(19) United States
(12) Patent Application Publication
(10) Pub. No.: US 2006/0040045 A1
(43) Pub. Date: Feb. 23, 2006

(54) Method of making electrodes for electrochemical fuel cells

(76) Inventors: Siegfried Limmer, Beuren (DE); Sabine Ansorge, Nuertingen (DE); Siyu Ye, Burnaby (CA); Paul D. Beattie, Port Moody (CA); Sonia G. Wong-Cheung, Burnaby (CA); Kyoung J. Bai, Cranbrook (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/922,112

(22) Filed: Aug. 18, 2004

(51) Int. Cl. B05D 5/12

(52) U.S. Cl. 427/115; 427/123; 427/369

(57) ABSTRACT

In preparing a fluid diffusion electrode, typical methods include applying a catalyst ink to a fluid diffusion layer, drying the catalyst ink and hot-pressing the coated fluid diffusion layer to produce a fluid diffusion electrode. In the present application, unexpected improvements in the smoothness of the resulting electrode have been observed by drying the catalyst ink during compaction. To assist with drying the catalyst layer, the compacting step may be performed at elevated temperatures. In some embodiments, a release sheet may be applied to the catalyst layer prior to compaction. In addition or alternatively, partial drying of the catalyst layer may occur prior to compaction.

### BACKGROUND OF THE INVENTION

1. Field of the Invention

The present invention relates to improved methods for making fluid diffusion electrodes for electrochemical fuel cells.

2. Description of the Related Art

Electrochemical fuel cells convert fuel and oxidant to electricity and reaction product. Polymer electrolyte membrane (“PEM”) fuel cells generally employ a membrane electrode assembly (“MEA”) comprising an ion-exchange membrane as electrolyte disposed between two electrically conductive electrodes. The electrodes typically comprise a fluid diffusion layer and electrocatalyst. The fluid diffusion layer comprises a substrate with a porous structure which renders it permeable to fluid reactants and products in the fuel cell.

Fluid reactants may be supplied to the electrodes in either gaseous or liquid form. In electrochemical fuel cells employing hydrogen as the fuel and oxygen as the oxidant, the catalyzed reaction at the anode produces hydrogen cations (protons) and electrons from the fuel. The gaseous reactants move across and through the fluid diffusion layer to react at the electrocatalyst. The ion-exchange membrane facilitates the migration of protons from the anode to the cathode while electrons travel from the anode to the cathode by the external load. At the cathode electrocatalyst layer, oxygen reacts with the protons that have crossed the membrane and the electrons to form water as the reaction product.

The electrocatalyst is typically disposed in a layer at each membrane/fluid diffusion layer interface, to induce the desired electrochemical reaction in the fuel cell. The electrocatalyst may be a metal black, an alloy or a supported catalyst, for example, platinum on carbon. The catalyst layer typically contains an ionomer, which may be similar to that used for the ion-exchange membrane (for example, up to 30% by weight Nafion® brand perfluorosulfonic-based ionomer). The catalyst layer may also contain a binder, such as polytetrafluoroethylene (PTFE). The electrocatalyst may be disposed as a layer on the fluid diffusion layer to form a fluid diffusion electrode or disposed as a layer on the ion-exchange membrane.

Materials commonly used as fluid diffusion layers or as starting materials to form fluid diffusion layers include carbon fiber paper, woven and nonwoven carbon fabrics, metal mesh or gauze, and other woven and nonwoven materials. Such materials are commercially available in flat sheets and, when the material is sufficiently flexible, in rolls. Fluid diffusion layers tend to be highly electrically conductive and macroporous and may also contain a particulate electrically conductive material and a binder. The substrate may be pre-treated with a water-repellant fluororesin (such as polytetrafluoroethylene), or with a mixture of a fluororesin and carbon black, to enhance water repellency. The fluid diffusion layer may also comprise a carbon or graphite sub-layer coated on one side thereon in order to reduce porosity, provide a surface for electrocatalyst, reduce surface roughness or achieve some other object. The sub-layer can be applied by any of the numerous coating, impregnating, filling or other techniques known in the art. For example, the sub-layer may be contained in an ink or paste that is applied to the substrate. The sub-layer may penetrate less than one half, such as less than one third, the thickness of the substrate.

In preparing a fluid diffusion electrode, it has been found desirable to reduce the surface roughness. However, there remains a need in the art for improved methods to reduce surface roughness of fluid diffusion electrodes. The present invention fulfills this need and provides further related advantages.

### BRIEF SUMMARY OF THE INVENTION

In preparing a fluid diffusion electrode, typical methods include applying a catalyst ink to a fluid diffusion layer, drying the catalyst ink and hot-pressing the coated fluid diffusion layer to produce a fluid diffusion electrode. In the present application, unexpected improvements in the smoothness of the resulting electrode have been observed by drying the catalyst ink during compaction. In particular, in an embodiment of the present invention, a method for preparing a fluid diffusion electrode comprises: providing a fluid diffusion layer; applying a catalyst ink comprising catalyst particles and a solvent to the fluid diffusion layer to form a catalyst layer on the fluid diffusion layer; and compacting the fluid diffusion layer and the catalyst layer until the catalyst layer has less than 8% solvent, and more particularly less than 5% solvent.

To assist with drying the catalyst layer, the compacting step may be performed at elevated temperatures, for example at temperatures at or greater than 50, 70, 100 or 140° C. and at temperatures at or below 450, 400, 300, 240 or 160° C. In various embodiments the compaction step occurs at or longer than 1, 2 or 4 minutes and at or less than 10, 9 or 7 minutes. Similarly, in various embodiments, the compaction may be at or greater than 5, 10 or 20 bar and at or less than 100, 60 or 40 bar.

A release sheet may optionally be applied to the catalyst layer prior to the compaction step. The release sheet may be, for example, at least one of polytetrafluoroethylene (PTFE) (Teflon®), an amorphous thermoplastic polyetherimide (Ultem®), polyvinylidene fluoride (PVDF) (Kynar®), THV impregnated paper (THV is a polymer of tetrafluoroethylene, hexafluoropropylene and vinylidene fluoride), or PE. The use of a release sheet may increase efficiency by eliminating or reducing the need to clean ink from the press. In an embodiment, the release sheet is non-porous or at least has a porosity less than the porosity of the fluid diffusion layer.

In yet a further embodiment, there may be a partial drying step prior to the compacting step. The partial drying may be in air or under a heating element for 6 minutes or less.

When a second fluid diffusion electrode is also produced, possibly by the same method as above, and bonded together with an ion-exchange membrane, a membrane electrode assembly may be formed.

These and other aspects of the invention will be evident upon reference to the attached figures and following detailed description.

### BRIEF DESCRIPTION OF THE DRAWINGS

FIG. 1 is an exploded side view schematic of a fluid diffusion electrode assembly 10 ready for compaction.

FIGS. 2-4 are optical images of fluid diffusion electrodes manufactured by methods of the present invention.

FIGS. 5-7 are optical images of fluid diffusion electrodes manufactured by prior art methods.

FIG. 8 is a scanning electron micrograph of a cross-section view of (a) the fluid diffusion electrode of FIG. 2 and (b) the fluid diffusion electrode of FIG. 6.

FIG. 9 is a graph of voltage as a function of current showing the performance of conventional electrode of FIG. 6 compared to the electrode of FIG. 2.

### DETAILED DESCRIPTION OF THE INVENTION

The present method for preparing a fluid diffusion electrode comprising a fluid diffusion layer and an electrocatalyst adhered to the fluid diffusion layer yields electrodes having reduced surface roughness. Peaks in the surface of one or both fluid diffusion electrodes may lead to perforations or leaks in ion-exchange membranes when assembled into an MEA. The fluid diffusion electrodes may cause perforations or leaks by penetrating the ion-exchange membrane or by reducing the thickness of the ion-exchange membrane. Pores or depression in the surface of the fluid diffusion electrode may also cause leaks, for example, as compressive stresses cause the membrane to flow into pores and other surface depressions when the MEA is heated, such as during bonding and fuel cell operation.

U.S. Pat. No. 4,849,253 discloses a typical method of manufacturing a fluid diffusion electrode wherein a plurality of thin catalyst layers are applied to a substrate with filtering and compaction of the layers between additions until the desired catalyst amount is achieved. The catalyst bearing substrate is then dried and sintered to form an electrode. However, it has been found that reduced surface roughness and surface cracking of the finished fluid diffusion electrode may be obtained if the sample is dried during compaction.

In particular, a fluid diffusion electrode may be manufactured by providing a fluid diffusion electrode and applying a catalyst ink thereon. The sample is then compacted until the sample is dry. For more efficient drying, heat may also be applied during the compaction step.

The catalyst ink may comprise supported or unsupported catalyst particles (for example, 40% platinum on carbon), a solvent, a binder, and ion-exchange material. Typical solvents include water, alcohol and mixtures thereof and typical binders include fluororesins such as polytetrafluoroethylene (PTFE), and perfluororesins such as Nafion®. The catalyst ink may also comprise pore formers such as methyl cellulose and surfactants. An improved interface between the catalyst layer and the ion-exchange membrane may be observed if the ion-exchange material used in the catalyst ink is the same as that used for the ion-exchange membrane though different materials may also be used.

The applying step may be performed in any of the known ways of coating, filling, or impregnating a substrate with an ink. A preferred way to apply the catalyst ink to the fluid diffusion layer is by using a knife coater or a comma bar, which applies a predetermined thickness of material to a surface. Another common method of applying the catalyst ink is by screen-printing the ink onto the fluid diffusion layer. In a continuous process, a power coater may be used to apply the catalyst ink.

Improved results may be observed if the compacting step uniformly and evenly subjects the fluid diffusion layer and the catalyst layer to a compressive pressure. The compaction step may be performed with any equipment suitable for applying a desired heat and pressure to a flat surface. For example, a reciprocating press may be employed to compact the fluid diffusion layer and catalyst layer. Alternatively, a heated continuous rolling press may be used such as a double belt bonder as disclosed in U.S. Patent Application No. 2002/0192548. The compacting step is preferably performed at a pressure of about 5 bar or more, and may be, for example, about 100 bar or less depending on materials and composition. The temperature used will depend on the material (sheet) used as well as the ionomer. Suitable temperatures may be for example between 50 and 250° C., and more particularly between 140 and 160° C. when Nafion® is used as binder in the catalyst ink. Specifically, the temperature should be sufficient to allow ion-exchange material in the catalyst layer to flow. The compacting may be for any suitable amount of time, for example, for about 10 minutes or less. Higher temperatures allow for shorter compacting times to be used.

A non-porous release sheet or a release sheet of low porosity may optionally be used between the reciprocating press and the catalyst layer. Without being bound by theory, the release sheet may force water from the catalyst layer to pass through to the fluid diffusion layer during drying. The release sheet may be any substance that is capable of forming a backing for a substrate during application and compaction yet remains easily removable such as by peeling from the fluid diffusion electrode. The use of a release sheet may increase efficiency by eliminating or reducing the need to clean ink from the press. For the purposes of this application, low porosity means that the release sheet has a lower porosity than the fluid diffusion layer. Suitable release materials include Mylar®, channeled resources Blue R/L 41113 release film, polyethylene coated paper, polytetrafluoroethylene (PTFE) (Teflon®), expanded PTFE, amorphous thermoplastic polyetherimide (Ultem®), polyvinylidene fluoride (PVDF) (Kynar®), metal or metal coated sheets, Teflon® coated materials, THV impregnated paper (THV is a polymer of tetrafluoroethylene, hexafluoropropylene and vinylidene fluoride), or PE or combinations thereof.

Prior to the compaction step, the sample may also be subject to a partial drying step. A partial drying step has been observed to allow more efficient peeling off of a release material from the finished fluid diffusion electrode. However, if the sample is dried completely prior to compaction, cracking along the edges of the fluid diffusion electrode may be observed.

When the catalyst layer is dried partially, it means that there remains some moisture that will not be present in the finished fluid diffusion layer. When the catalyst layer is dried “completely”, it means that the moisture content remaining is approximately that which will be present in the finished fluid diffusion electrode. Typically, a finished fluid diffusion electrode has a moisture content of about 10% or less, more commonly about 5% or less, at ambient temperature and humidity.

Partial drying steps may be performed in any of the known ways. For example, drying may be performed by using a conveyor oven under controlled humidity and temperature or even by air evaporation at ambient conditions. Alternatively, an infrared lamp may be used at a suitable temperature, for example, between about 60° C. and about 80° C.

Prior to the compaction step, the sample may also be subject to additional treatment steps. For example, an ionomer solution in water or alcohol may be sprayed on the catalyst layer. This has been found to aid in the release of the release sheet and reduce process cycle time.

Fluid diffusion electrodes with reduced surface roughness and reduced cracking may impart several advantages to electrochemical fuel cells. For example, reduced surface roughness and reduced cracking would be expected to lead to a better interface between the catalyst layer and the ion-exchange membrane and hence better fuel cell performance. Reduced cracking may also allow for the use of thinner membranes less than 30 μm thick as excessive flow and thinning of the membrane may be avoided.

### EXAMPLES

Trial 1

Fluid diffusion layers were prepared by teflonating TGP-H-060 sheets from Toray Industries, Inc. and printing a carbon sublayer thereon. The carbon sublayer contained carbon powder, polytetrafluoroethylene and methyl cellulose. A catalyst ink containing platinum catalyst on carbon support and Nafion® ionomer was also prepared and screen printed on the fluid diffusion layer to form a catalyst layer thereon. The catalyst layer was then air dried for 5 minutes at ambient temperature. The sample was then prepared for compaction as follows:

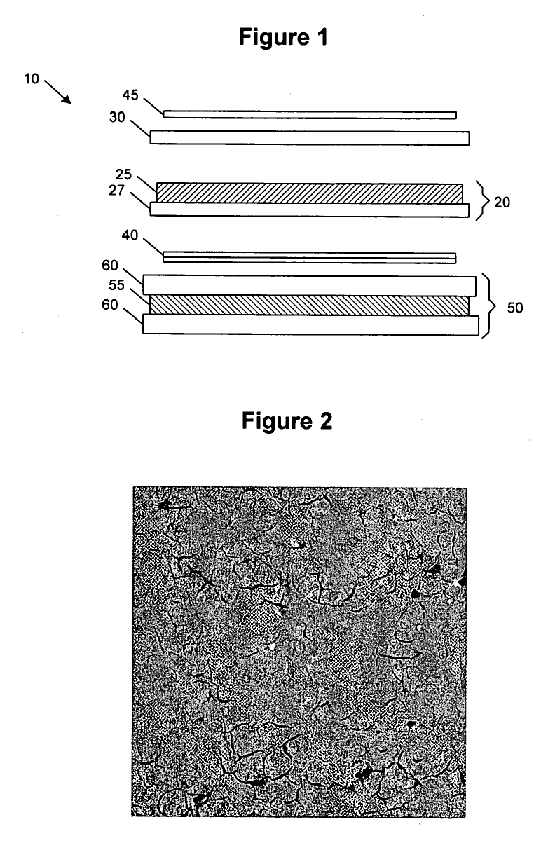

FIG. 1 is an exploded side view schematic of a fluid diffusion electrode assembly 10 ready for compaction. Fluid diffusion electrode assembly 10 comprises a fluid diffusion electrode 20 having a partially dried catalyst layer 25 on a fluid diffusion layer 27. A 50 μm thick polytetrafluoroethylene (PTFE) release sheet 30 was subjected to a precompression step by applying pressure at 100 bar for 2 minutes at 150° C. and then at 100 bar for 3 minutes between cooling plates before being applied to catalyst layer 25 using a stainless steel rolling bar (not shown). The precompression step removed wrinkles that may otherwise be present in PTFE release sheet 30. The stainless steel rolling bar was used to prevent wrinkles or air pockets forming as release sheet 30 was applied to catalyst layer 25.

Fluid diffusion electrode 20 was then placed on two filter papers 40 on compression assembly 50. Compression assembly 50 comprises an expanded graphite sheet 55 interposed between two 100 μm thick PTFE sheets 60. Expanded graphite sheet 40 and PTFE sheets 60 helps to achieve improved pressure distribution across fluid diffusion electrode 20 during compaction. The filter papers act as an absorbing material to trap any water eliminated from fluid diffusion electrode 20 during compaction.

As with PTFE release sheet 30, compression assembly 50 was also precompressed at 100 bar for 10 seconds at 150° C. and then at 100 bar for 20 seconds between cooling plates prior to use in fluid diffusion electrode assembly 10. A third filter paper 40 was then placed on top of PTFE release sheet 30. Fluid diffusion electrode assembly 10 was then ready for compaction.

The sample was then compacted at 9 bar for 5 minutes at 150° C. PTFE release sheet 30 was removed while the fluid diffusion electrode was still warm.

General techniques useful for evaluating the roughness of a surface include qualitatively or quantitatively measuring the surface such as by optical surface analysis. FIG. 2 is a scanning electron micrograph of the fluid diffusion electrode showing a crack area of 4.5%.

Trial 2

A catalyst ink prepared as in Trial 1 was applied by a knife coater on a fluid diffusion layer also prepared as in Trial 1 to form a catalyst layer thereon. The knife coater blade was set at 12.5 μm. The catalyst layer was then air dried for 5 minutes at ambient temperature. The sample was then prepared for compaction as in trial 1 and subsequently compacted at 9 bar for 5 minutes at 150° C. The PTFE release sheet was removed while the fluid diffusion electrode was still warm.

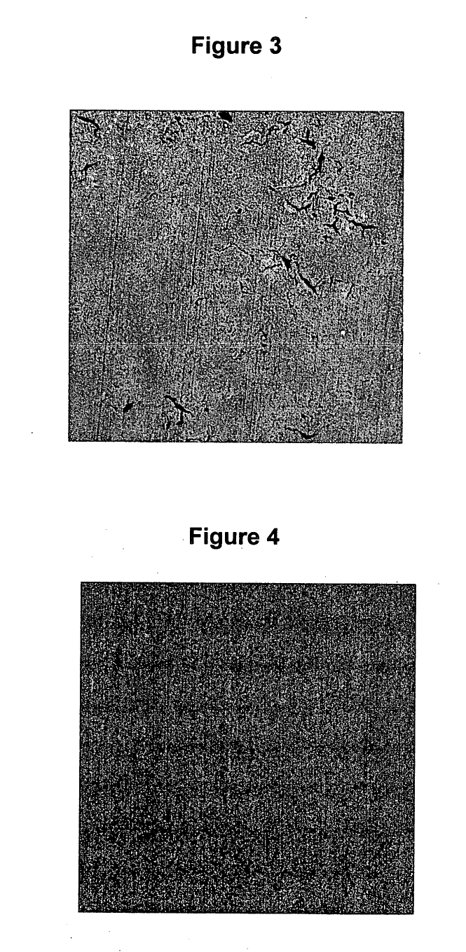

FIG. 3 is a scanning electron micrograph of the fluid diffusion electrode showing a crack area of 2.5%.

Trial 3

A catalyst ink prepared as in Trial 1 was applied by a knife coater on a fluid diffusion layer also prepared as in Trial 1 to form a catalyst layer thereon. The knife coater blade was set at 12.5 μm. The catalyst layer was then air dried for 5 minutes at ambient temperature. The sample was then prepared for compaction as in trial 1 and subsequently compacted at 9 bar for 5 minutes at 150° C. The PTFE release sheet was removed while the fluid diffusion electrode was still warm.

FIG. 4 is a scanning electron micrograph of the fluid diffusion electrode. While a crack area was not determined for this electrode, visual inspection of the micrograph compares favourably to the electrodes manufactured in trials 1 and 2 above.

Comparative Trial 1

A catalyst ink prepared as in Trial 1 was screen printed on a fluid diffusion layer also prepared as in Trial 1 to form a catalyst layer thereon. The catalyst layer was then air dried for 5 minutes at ambient temperature. The sample was then prepared for compaction as in trial 1 and subsequently compacted at 9 bar for 20 seconds. The sample was then dried at 55° C. for 6 minutes in an oven.

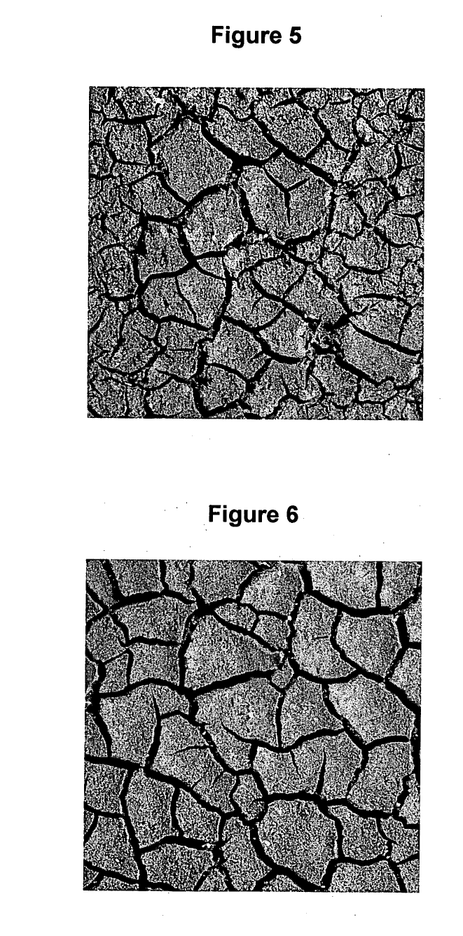

FIG. 5 is a scanning electron micrograph of the fluid diffusion electrode showing a crack area of 13.9%.

Comparative Trial 2

A catalyst ink prepared as in Trial 1 was applied by a knife coater on a fluid diffusion layer also prepared as in Trial 1 to form a catalyst layer thereon. The knife coater blade was set at 12.5 μm. The catalyst layer was then air dried for 5 minutes at ambient temperature. The sample was then prepared for compaction as in trial 1 and subsequently compacted at 9 bar for 20 seconds. The sample was then dried at 55° C. for 6 minutes in an oven.

FIG. 6 is a scanning electron micrograph of the fluid diffusion electrode showing a crack area of 15.4%.

Comparative Trial 3

A catalyst ink prepared as in Trial 1 was applied by a knife coater on a fluid diffusion layer also prepared as in Trial 1 to form a catalyst layer thereon. The knife coater blade was set at 12.5 μm. The catalyst layer was then air dried for 5 minutes at ambient temperature. The sample was then prepared for compaction as in trial 1 and subsequently compacted at 9 bar for 20 seconds. The sample was then dried at 70° C. for 10 minutes on a hot plate.

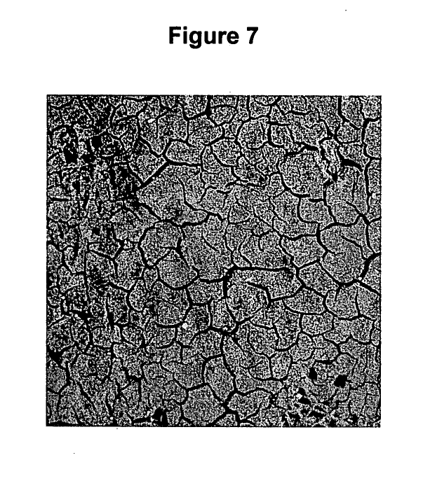

FIG. 7 is a scanning electron micrograph of the fluid diffusion electrode showing a crack area of 11.4%.

Further Analysis

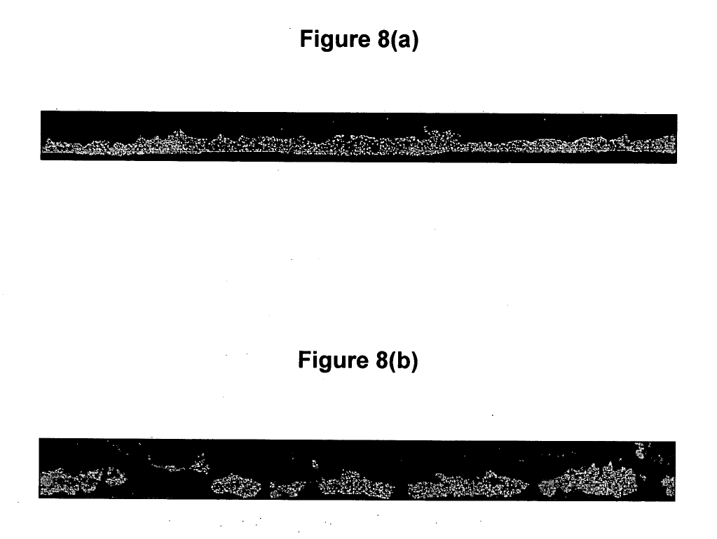

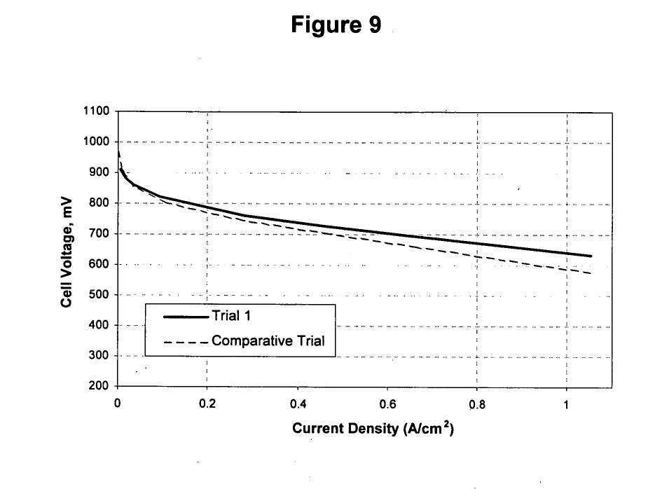

The electrode under Trial 1 was compared further with the electrode under Comparative Trial 1. FIG. 8(a) is a cross-sectional scanning electron micrograph of the electrode of Trial 1 and FIG. 8(b) is a cross-sectional scanning electron micrograph of the electrode of Comparative Trial 1. The electrode of Trial 1 is clearly smoother with fewer cracks. A Wyco roughness test was performed with the results shown below in Table 1.

| | | Comparative |
|---|---|---|
| | Trial 1 | Trial 1 |
| Ra (μm) | 5.3 | 7.7 |
| Rq (μm) | 6.6 | 9.7 |
| Rz (μm) | 31.7 | 49.8 |

Ra is the mean distance from the “zero” line. The “zero” line is the mean height overall, in other words, half the surface is above the zero line and half the surface is below the zero line. Rq is the root-mean-square distance from the zero line. High peaks and low valleys get a higher weighting in measuring Rq. Rz is the distance from peak to trough where peak is the average height of the peak in 480 different lines. The electrode made under an embodiment of the present invention is thus quantitatively smoother than a prior art electrode.

Smoother electrodes may lead to, among other advantages, to improved performance. This is clearly seen in FIG. 9. FIG. 9 is a graph of voltage as a function of current where the electrode from Trial 1 is shown as a solid line and the electrode from Comparative Trial 1 is shown as a dashed line. The smoother electrode of Trial 1 demonstrates a significant and unexpected improvement as a result of the present invention.

### CONCLUSIONS

All of the SEM in FIGS. 2-7 have a magnification of 200 and each micrograph has an area of 2×2 mm real size. Trials 1, 2 and 3 showed considerable improvements in surface roughness as compared to Comparative Trials 1, 2 and 3. In particular, Trials 1-3 had crack areas of only 2.5-4.5% or even less as compared to crack areas of 11.4-15.4% for Comparative Trials 1-3. Smoother electrodes may lead to a better interface between the catalyst layer and the fluid diffusion layer and between the catalyst layer and the ion-exchange membrane. This in turn may lead to improved performance among other benefits.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing, it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A method for preparing a fluid diffusion electrode comprising:
providing a fluid diffusion layer;
applying a catalyst ink comprising catalyst particles and a solvent to the fluid diffusion layer to form a catalyst layer on the fluid diffusion layer; and
compacting the fluid diffusion layer and the catalyst layer until the catalyst layer has less than 8% solvent.

2. The method of claim 1 wherein the catalyst layer has less than 5% solvent after the compacting step.

3. The method of claim 1 wherein the compacting step is at elevated temperatures.

4. The method of claim 2 wherein the elevated temperatures are between 50 and 450° C.

5. The method of claim 2 wherein the elevated temperatures are between 140 and 160° C.

6. The method of claim 1 wherein the compaction step is for between 1 and 10 minutes.

7. The method of claim 1 wherein the compaction step is for between 4 and 7 minutes.

8. The method of claim 1 wherein the compaction step is between 5 and 100 bar.

9. The method of claim 1 wherein the compaction step is between 20 and 40 bar.

10. The method of claim 1 further comprising partially drying the catalyst layer prior to the compacting step.

11. The method of claim 10 wherein the partially drying step comprises drying the catalyst layer in air.

12. The method of claim 11 wherein the partially drying step is for 6 minutes or less.

13. The method of claim 1 wherein the applying step is performed with a knife coater.

14. The method of claim 1 further comprising applying an ionomer solution to the catalyst layer prior to the compacting step.

15. The method of claim 1 further comprising applying a release sheet to the catalyst layer prior to the compacting step.

16. The method of claim 15 wherein the porosity of the release sheet is less than the porosity of the fluid diffusion layer.

17. The method of claim 15 wherein the release sheet comprises at least one of polytetrafluoroethylene, amorphous thermoplastic polyetherimide, polyvinylidene fluoride, THV impregnated paper, or PE.

18. The method of claim 15 wherein the release sheet comprises polytetrafluoroethylene sheets.

19. The method of claim 15 further comprising removing the release sheet after the compacting step.

20. The method of claim 1 wherein the compacting step produces a first fluid diffusion electrode, the method further comprising:
providing an ion-exchange membrane;
providing a second fluid diffusion electrode; and
bonding the first fluid diffusion electrode, the ion-exchange membrane and the second fluid diffusion layer together to form a membrane electrode assembly.

21. The method of claim 20 wherein the providing a second fluid diffusion layer comprises:
providing a second fluid diffusion layer;
applying a second catalyst ink to the second fluid diffusion layer to form a second catalyst layer on the second fluid diffusion layer; and
compacting the second fluid diffusion layer and the second catalyst layer until the second catalyst layer has less than 8% solvent.
